(19) United States
(12) Patent Application Publication
(10) Pub. No.: US 2016/0203433 A1
(43) Pub. Date: Jul. 14, 2016

(54) OPTIMIZATION OF TRAIT AND EXPERTISE FOR WORKFORCE SELECTION

(71) Applicant: International Business Machines Corporation, Armonk, NY (US)

(72) Inventors: Jilin Chen, Sunnyvale, CA (US); Jalal U. Mahmud, San Jose, CA (US); Aditya Pal, San Jose, CA (US); N. Sadat Shami, Scarsdale, NY (US); Fei Wang, Fremont, CA (US)

(21) Appl. No.: 14/594,200

(22) Filed: Jan. 12, 2015

(51) Int. Cl. G06Q 10/06

(52) U.S. Cl. CPC G06Q 10/063112

(57) ABSTRACT

A computer-implemented method for optimizing information workforce selection is provided. The computer-implemented method includes providing a ground-truth data collection of information of a plurality of candidates for a group or a team workforce selection. The computer-implemented method further includes determining at least one expertise and at least one trait characteristic, or at least one feature of each of the candidates within the plurality of candidates. The computer-implemented method further includes performing trait compability analysis that provides a compatibility score of potential candidates of the plurality of candidates, for a group. The computer-implemented method further includes performing a collaboration compability analysis that provides a collaboration compatibility score of plurality of potential candidate within the plurality of candidates. The computer-implemented method further includes optimizing at least one individual candidate or a team of candidates within the plurality of candidates, for the workforce selection.

### FIELD OF INVENTION

The present invention generally relates to computing systems, and more particularly to enterprise system optimization of traits and expertise of individuals or employees, for workforce selection, in a team workflow environment.

### BACKGROUND

Workforce selection, including, for instance, selection of individuals, or employees to engage in work projects of a company, or an organization, can play an important role in the success of the work project. Selecting the right employees or the right team, for the right project, or job, can be an initial step for achieving the goal of the project, for the company, or the organization. Selection of the right employees can also ensure high productivity of an individual, as well as a team, during the course of the project. Further, cost, complexity, and need to effectively manage human resources of a project, or job, of organizations, or companies, has been long recognized in workforce selection. For example, with increasingly sophisticated workforces, of correspondingly increasing accumulated value, the process of acquiring, training, managing, and retaining a workforce, if effective, can preserve and deliver substantial value to workforce organizations, including employer companies and volunteer agencies.

### SUMMARY

According to one embodiment, a computer-implemented method for optimizing information for workforce selection, based on modeling of intrinsic traits and expertise of an individual or a team, the computer-implemented method comprising is provided. The computer implemented method comprises providing a ground-truth data collection of information of a plurality of candidates for a group or a team workforce selection, the ground-truth data collection includes performance rating assessments of the candidates. The computer-implemented method further comprises determining at least one expertise and at least one trait characteristic, or at least one feature of each of the candidates within the plurality of candidates, based on the ground-truth data collection, for the group or the team workforce selection. The computer-implemented method further comprises performing a trait compability analysis that provides a compatibility score of potential candidates, of the plurality of candidates, for the group, the trait compability analysis utilizes a supervised model that determines compatibility of the potential candidates for the group, based on a co-efficient of the expertise and traits characteristics, as functions of the potential candidates. The computer-implemented method further comprises performing a collaboration compability analysis that provides a collaboration compatibility score of plurality of potential candidate within the plurality of candidates, for performing a task of the workforce by a pair of candidates, based on a prior collaboration history and a collaborative expertise and a plurality of collaborative traits characteristics of the plurality of potential candidates. The computer-implemented method further comprises optimizing at least one individual candidate or a team of candidates within the plurality of candidates, for the workforce selection for performing a specific task, based on a result of the trait compability analysis and the collaboration compability analysis.

According to another embodiment, a computer system for individual or team workforce selection based on modeling of intrinsic traits and expertise of the individual or team, for workforce selection, is provided. The computer system includes one or more processors, one or more computer-readable memories, one or more computer-readable tangible storage devices and program instructions which are stored on at least one of the one or more storage devices for execution by at least one of the one or more processors via at least one of the one or more memories. The computer system further includes program instructions to provide a ground-truth data collection of information of a plurality of candidates for a group or a team workforce selection, the ground-truth data collection includes performance rating assessments of the candidates. The computer system further includes program instructions to determine at least one expertise and at least one trait characteristic, or at least one feature of each of the candidates within the plurality of candidates, based on the ground-truth data collection, for the group or the team workforce selection. The computer system further includes program instructions to perform a trait compability analysis that provides a compatibility score of potential candidates, of the plurality of candidates, for the group, the trait compability analysis utilizes a supervised model that determines compatibility of the potential candidates for the group, based on a co-efficient of the expertise and traits characteristics, as functions of the potential candidates. The computer system further includes program instructions to perform a collaboration compability analysis that provides a collaboration compatibility score of plurality of potential candidate within the plurality of candidates, for performing a task of the workforce by a pair of candidates, based on a prior collaboration history and a collaborative expertise and a plurality of collaborative traits characteristics of the plurality of potential candidates. The computer system further includes program instructions to optimize at least one individual candidate or a team of candidates within the plurality of candidates, for the workforce selection for performing a specific task, based on a result of the trait compability analysis and the collaboration compability analysis.

According to yet another embodiment, computer program product for optimizing information for workforce selection, based on modeling of intrinsic traits and expertise of an individual or a team, is provided. The computer program product includes one or more computer-readable tangible storage devices and program instructions stored on at least one of the one or more storage devices. The computer program product further includes program instructions to provide a ground-truth data collection of information of a plurality of candidates for a group or a team workforce selection, the ground-truth data collection includes performance rating assessments of the candidates. The computer program product further includes program instructions to determine at least one expertise and at least one trait characteristic, or at least one feature of each of the candidates within the plurality of candidates, based on the ground-truth data collection, for the group or the team workforce selection. The computer program product program instructions to perform a trait compability analysis that provides a compatibility score of potential candidates, of the plurality of candidates, for the group, the trait compability analysis utilizes a supervised model that determines compatibility of the potential candidates for the group, based on a co-efficient of the expertise and traits characteristics, as functions of the potential candidates. The computer program product further includes program instructions to perform a collaboration compability analysis that provides a collaboration compatibility score of plurality of potential candidate within the plurality of candidates, for performing a task of the workforce by a pair of candidates, based on a prior collaboration history and a collaborative expertise and a plurality of collaborative traits characteristics of the plurality of potential candidates. The computer program product further includes program instructions to optimize at least one individual candidate or a team of candidates within the plurality of candidates, for the workforce selection for performing a specific task, based on a result of the trait compability analysis and the collaboration compability analysis.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 illustrates the components and algorithms associated with a computing device according to at least one embodiment;

FIG. 3 illustrates the components and algorithms associated with server according to at least one embodiment

FIG. 4 is an operational flowchart illustrating the steps carried out by a program for a workforce selection system, for optimizing information for workforce selection of a task, or project, based on modeling of intrinsic traits and expertise of a plurality of individuals or teams according to at least one embodiment;

FIG. 5 is a block diagram of internal and external components of computers and servers depicted in FIG. 1 according to at least one embodiment.

### DETAILED DESCRIPTION

Detailed embodiments of the claimed structures and methods are disclosed herein; however, it may be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Generally, workforce selection is based on expertise, such as, academic qualification, experience, or knowledge, of individuals, or employees to engage in work projects of a company, or an organization. Expertise impacts the success of the workforce. For example, a software development team that needs to develop visualization software must have certain team members who are experts on visualization. In this case, typically, if the development goal of the software development team includes building a data mining tool, the team should include a data mining expert. However, a person's traits, such as, personality and basic human values can also be important for his/her job performance. For instance, an extroverted individual can become successful in sales or customer relationship management. An individual who is highly “hedonistic”, which is a basic human value attribute that can indicated desire for pleasure, may be successful in work that involves outdoor activities and travel. A conscientious or more organized individual may be successful in work which requires managing a project or team.

Thus, traits of an individual, along with expertise of the individual, can give management or hiring teams more insight in workforce selection process, and thus provide help or assistance in recruitment decisions. Such traits of an individual not only affects an employee's performance in an organization, but also affect a group or team which desires to achieve a common goal, such as developing a new product in a software organization, or organizing an event, for the company or organization. Also, apart from the ability of individual team members to contribute to the success of the team, it can also be important to match people in the team who can effectively collaborate with each other. Personality of participants in a team can be an important characteristic for the nature of collaboration among its members. For instance, if a team contains too many introverted people, then an extravert who may be added to the team may not find it easy to work with the introverted individuals in the team. As another example, a team may be full of people who are not very agreeable. Similarly, a team may not succeed if individuals on the team are more depressed. Thus, it is desirable to have individuals that fit the culture of the team they are hired, or selected into. Therefore, there is a need for workforce oriented teams to be well balanced team, with strong traits, or expertise, such that there is diversity in personality, values, expertise, style etc. of individuals or teams, whom are involved in a workforce task or project, of a company or organization.

Embodiments generally relate to workflow scheduling systems, and more particularly to enterprise system optimization of traits and expertise of individuals or employees, for workforce selection, in a team workflow environment. The embodiments include one or more circuits, or subassemblies of circuits, as well as, a system, or computer-implemented methods of operation for determining workforce selection scores, for individuals, or teams.

Additionally, embodiments also include displaying graphical representations of the workforce selection scores, based on expertise or traits of the individuals or teams, whom are candidates of a workforce selection, whereby, the workforce selection scores are based on trait compatibility scores of a trait compability analysis, collaboration compatibility scores, of collaboration compability analysis, and an optimized total fitness score, for the individuals or teams, based on the compability analysis and the collaboration compability analysis, for performing a specific workforce task. Additionally, the present embodiment has the capacity to improve the technical field of workflow scheduling systems, based on enterprise system optimization of traits and expertise of individuals or employees, for workforce selection, in a team workflow environment.

The present invention may be a system, a method, and/or a computer program product. The computer program product may include a computer readable storage medium (or media) having computer readable program instructions thereon for causing a processor to carry out aspects of the present invention.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that may direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

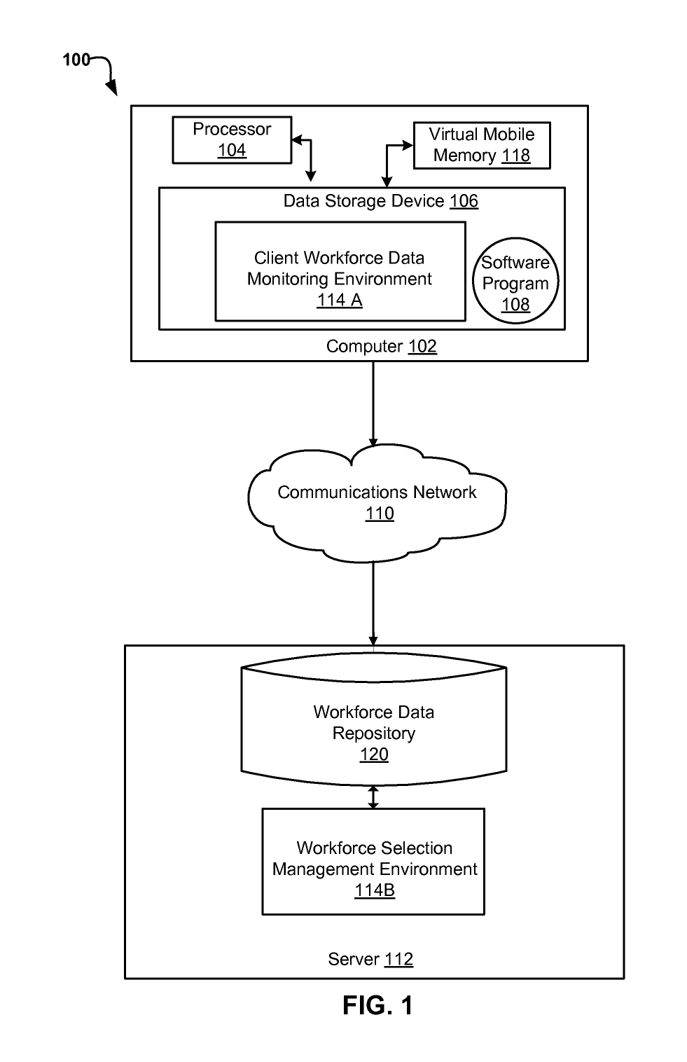

The embodiments will now be described in detail with reference to the accompanying Figures. Referring now to FIG. 1, a workforce selection system 100, for optimizing information for workforce selection of a task, or project, based on modeling of intrinsic traits and expertise of a plurality of individuals or teams, whereby, a trait compability score, collaboration compability score, is determined, for selecting individual candidates, or a team of candidates, of the plurality of individuals or teams, for the workforce selection, according to embodiments, is depicted.

The workforce selection system 100 may include a computer 102, with a processor 104, and a data storage device 106 that is enabled to run, or execute program instructions of a software program 108. The computer 102 may also include a client workforce data monitoring environment 114A, interconnected over communications network, with server 112, for managing an administrative computing interface, for detecting, acquiring, or logging, a compiled ground truth data collection of information, of workforce resource skills, of individuals, or teams, such as, work related knowledge, or skills of the individual or teams, historical performance evaluations, or success rates of previous problems or historical records of workflows performed by the individual, or teams, within an organization, or a company. The server 112 operates a workforce selection management environment 114B for determining compability scores and collaboration scores, for selecting individual candidates, or a team of candidates, of the plurality of individuals or teams, for the workforce selection, according to embodiments.

The communications network 110 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

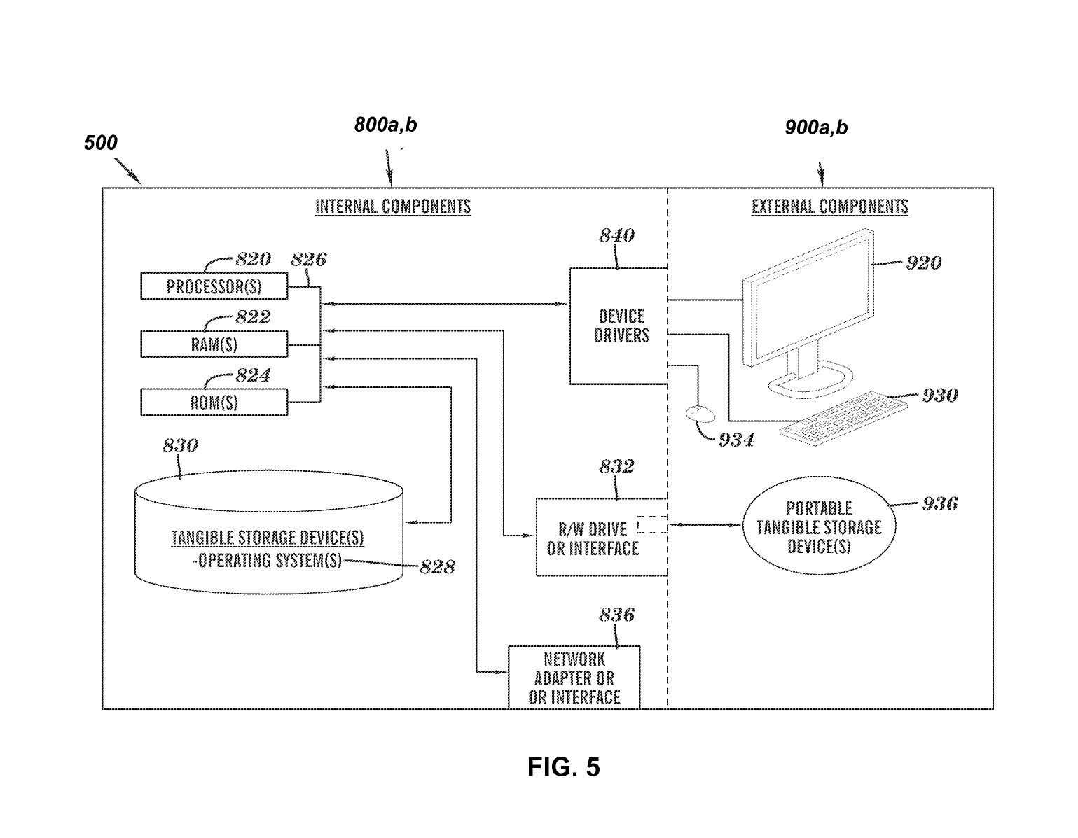

The computing device 102 may communicate with the resource workflow monitoring application 114B, running on server 112, via the communication network 110, for optimizing information for workforce selection of a task, or project, based on modeling of intrinsic traits and expertise of a plurality of individuals or teams, of the computing device 102. The communications network 110 may also include connections, such as wire, wireless communication links, or fiber optic cables. As will be discussed with reference to FIG. 5, server 112 may include internal components 800a and external components 900a, respectively, and computer 102 may include internal components 800b and external components 900b, respectively.

The computer 102 may be, for example, a laptop, tablet, or notebook personal computer (PC), a desktop computer, a mainframe or mini computer, or a personal digital assistant (PDA). The computer 102 can also be any portable device that provides computing, information storage and, computing retrieval capabilities, including, for example, a handheld device, or handheld computer, pocket PC, connected organizer, electronic book (eBook) reader, a personal digital assistant (PDA), a smart phone, or other portable devices, or any type of computing devices capable of accessing a network for optimizing information for workforce selection of a task, or project, based on modeling of intrinsic traits and expertise of a plurality of individuals or teams. The database storage device 106 is any type of storage device, storage server, storage area network, redundant array of independent discs (RAID), cloud storage service, or any type of data storage. The database storage device 106 can also be a relational model database server for storing program instructions for optimizing information for workforce selection of a task, or project, based on modeling of intrinsic traits and expertise of a plurality of individuals or teams, in a computing interface of the computer 102.

The virtual mobile memory 118 of the computer 102 may comprise, for example, one or more computer-readable storage media, which may include random-access memory (RAM) such as various forms of dynamic RAM (DRAM), e.g., DDR2 SDRAM, or static RAM (SRAM), flash memory, or any other form of fixed or removable mobile computing storage medium that may be used to carry or store desired program code and program data in the form of instructions or data structures and that may be accessed by other components of the virtual mobile memory 118, for ensuring that display of the interface for managing an administrative computing interface, for detecting, acquiring, or logging, a compiled ground truth data collection of information, of workforce resource skills, of individuals, or teams, such as, work related knowledge, or skills of the individual or teams, historical performance evaluations, or success rates of previous problems or historical records of workflows performed by the individual, or teams, are adequately configured, based on preferences of a client, or system, for executing the plan for the workload structure.

The server 112 can be, for example, a mainframe server computing system such as a management server, a workforce management web server, an employment database management server, or any other electronic device, or workforce related server, or central computing server system that is capable of receive and sending data, and, also, serving as an intersection for performing optimization of information for workforce selection of a task, or project, based of intrinsic traits and expertise of a plurality of individuals or teams. For example, the server 112 is capable of transmitting analyzed compability or collaboration data of the optimized information, of the teams or individuals, as scores, for display in an interface of the client workforce data monitoring environment 114A.

The server 112 can also represent a “cloud” of computers interconnected by one or more networks, whereby, the server 112 is a primary server of a plurality of server computing systems that utilizes clustered computers, when accessed through the communication network 110. The workforce data repository 120, of server 112, is any type of storage device, storage server, storage area network, redundant array of independent discs (RAID), cloud storage service, or any type of data storage for storing information relating optimization of information for workforce selection of a task, or project, based on modeling of intrinsic traits and expertise of a plurality of individuals or teams. Similarly, the workforce data repository 120 can also be a relational model database server for storing program instructions for displaying algorithmic results of optimized individual candidates, or a team of candidates of the plurality of candidates, for the workforce selection for performing a specific task, based on results of a compability analysis and a collaboration compability analysis.

The relational model for database management of the workforce data repository 120 may be based on first-order predicate logic. For example, in the relational model of a database, all data execution of algorithmic results of the workforce selection are represented in terms of tuples, grouped into relations. In the relational model of the algorithmic results selected individual candidates, or a team of candidates, of the plurality of individuals or teams are linked together, based on a computing-based modeling of intrinsic traits and expertise of a plurality of individuals or teams. For example, at least one function of the relational model of the workforce data repository 120 is to provide a declarative method for specifying data and queries of algorithmic results of selected individual candidates, whereby, users, clients, or systems administrators of the workforce selection system 100 can directly state what information they would like to retrieve from the workforce data repository 120. As such, the resource workforce selection management environment 114B may provide a platform for implementing client retrieval mechanisms, for categorizing data structures, for storing data of algorithmic results of selected individual candidates, and also, retrieval of procedures, for answering queries, for retrieving the data of computed scores for workforce selection, within the workforce selection system 100, according to embodiments.

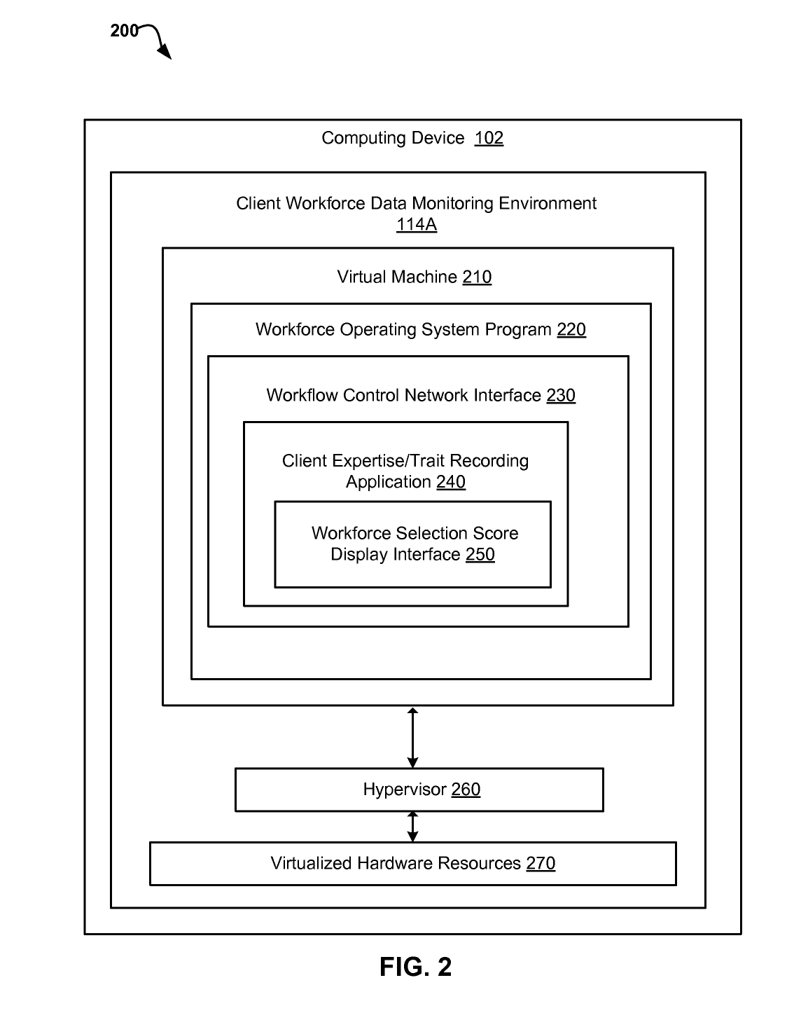

Referring now to FIG. 2, a functional block diagram 200 illustrating program components and algorithms associated with client workforce data monitoring environment 114A, in accordance with embodiments. The client workforce data monitoring environment 114A may be a web browser plug-in system application program that provides an administrative user-interface, for detecting, acquiring, or logging, a compiled ground truth data collection of information, of workforce resource skills, of individuals, or teams, such as, work related knowledge, or skills of the individual or teams, historical performance evaluations individual or teams, or success rates of previous problems or historical records of workflows performed by the individual, or teams, within an organization, or a company, according to embodiments.

The client workforce data monitoring environment 114A displays, in the user-interface, compatibility scores of a trait compability analysis, collaboration compatibility scores, of collaboration compability analysis, and an optimized, total fitness score for the individuals or teams, based on the compability analysis and the collaboration compability analysis, for performing a specific workforce task, according to embodiments. The client workforce data monitoring environment 114A may display, in the interface, workforce selection score analysis, of individual or teams, in virtualized, graphical representations, whereby, the virtualized display can be based on customized configurations by an administrator, or client, for displaying graphical images of the scores, for selecting a workforce from a plurality of candidates of the individual or teams, for performing the specific task, based on the analyzed workforce selection.

The client workforce data monitoring environment 114A may access the resource workforce selection management environment 114B, running on server 112, for displaying scores of individuals or candidates, for workforce selection, for performing a specific workforce task. The client workforce data monitoring environment 114A may be centralized on the server 112, and also it may be divided between two different components: server-side and client-side.

The workforce selection management environment 114B, running on server 112 may interact with the web browser of client workforce data monitoring environment 114A, for transmission of the user configurations for displaying graphical representations of the scores of individuals or candidates, for workforce selection, for performing a specific workforce task data, in the interface of computer 102. For instance, the client workforce data monitoring environment 114A may implement a virtualized computing platform for displaying graphical representation for displaying graphical representations of the scores, based on client display preferences, in a data visualization display engine of the client workforce data monitoring environment 114A.

Also, the client workforce data monitoring environment 114A may include a hardware virtualization system that enables multiple operating systems, or virtual machines to run or operate simultaneously, and display virtual, graphical representations of scores in the user-interface of the client workforce data monitoring environment 114A. For example, in the illustrated environment, the client workforce data monitoring environment 114A includes virtual machine (VM) 210, hypervisor 260 and virtualized hardware resources 270. The VM 210 provides a virtualized system application platform for supporting the display of the graphical representations of the scores in the user-interface. The VM 210 also executes programs, or applications in operating system (OS) 220, for displaying the graphical representations of the scores of individuals or candidates, for workforce selection, for performing a specific workforce task in the client workforce data monitoring environment 114A.

For example, the VM 210 utilizes data or information, for displaying various representations of the scores, whereby, the utilized data can be based on detected, acquired, or logged ground truth data collection of information, of workforce resource skills, of the individuals, or the teams, such as, work related knowledge, or skills of the individual or teams, historical performance evaluations individual or teams, or success rates of previous problems or historical records of workflows performed by the individual, or teams, within an organization, or a company.

The VM 210 can also utilize data of the ground truth data collection of information from multi-media contents, such as, pre-computed knowledge based information, or analyzed data of social media contents, including, identified tags of multi-media contents of a text-based data, a voice-based data, or a video-based data of incoming media stream pertaining to the individual or team. For example, the system also extracts additional media content of the text-based data, the voice-based data, or the video-based data, keywords, or topics discussed, identified, detected, or mentioned in media content of the incoming media stream, of the multi-media contents, for providing further information pertaining to personality, expertise, or traits of the individuals or candidates, according to embodiments.

The VM 210 may also execute program instructions, within OS 220, for displaying the information, or data, in a virtualized data format, for displaying workforce selection scores of the individual or team based on compability analysis or the collaboration compability analysis, for performing a specific workforce task. For example, the OS 220 may be Microsoft Windows® (Microsoft Windows and all Microsoft Windows-based trademarks and logos are trademarks or registered trademarks of Microsoft, Inc. and/or its affiliates) or Android® OS (Android and all Android-based trademarks and logos are trademarks or registered trademarks of Google, Inc. and/or its affiliates). The virtualized hardware resources 270 may include, for example, virtual processors, virtual disks, virtual memory or virtual network interfaces that are allocated hypervisor virtualizes virtualized hardware resources 270, and controls processor scheduling and memory partitions for executing program operations of OS 220, for displaying for displaying workforce selection scores of the individuals or teams, based on compability analysis or the collaboration compability analysis, for performing a specific workforce task.

The workflow control network interface 230 may be a web browser application, a standalone web page graphics display application or part of a service that monitors and interacts with a web browser or graphical display application of VM 210, for displaying workforce selection. The control network interface 230 may, among other things, retrieve and display mobile contents of workforce selection system 100100 (FIG. 1) via communications network 110 (FIG. 1), between client workforce data monitoring environment 114A and workforce selection management environment 114B.

The control network interface 230 includes an expertise and trait recording application 240. Expertise and trait recording application 240 can include program code, such as, Hypertext Markup Language (HTML) code or JavaScript code that, when executed, adds the additional user interface elements to the user interface of client program 111. The additional user interface elements of workforce selection management environment 114B monitors expertise or trait resource skills of individuals or teams for the workforce selection, for performing a specific task, based on a compilation of client resource skills of ground truth data collection of information, of the individuals or teams, detected, and recorded, in the workforce repository 120, of the workforce selection management environment 114B.

The client recourse skills can be a collection of information of the individuals or teams that are detected, acquired, or logged, in a form of compiled ground truth data collection of information, of workforce related expertise or personal traits, for workforce selection for the individuals, or teams, such as, work related knowledge, or skills of the individual or teams, historical performance evaluations individual or teams, or success rates of previous problems or historical records of workflows performed by the individual, or teams, geography locations of the individual, or teams, or technical skills of the individual, or teams.

For example, workforce selection management environment 114B monitors program executions of client workforce monitoring data environment 114A of the workforce resource skills of the individual, or teams, based on expertise or traits of the individuals or teams, periodically, randomly, and/or using event-based monitoring, and stores the monitored resource skill in workforce data repository 120, for determining, by the workforce selection management environment 114B, workforce selection scores of the individuals or teams, based on the trait compability analysis, collaboration compatibility scores, of collaboration compability analysis, and an optimized, total fitness score for the individuals or teams, based on the compability analysis and the collaboration compability analysis, for performing a specific workforce task, according to embodiments.

Client expertise and trait recording application 240 includes workforce selection score display interface 250. Workforce selection score display interface 250 provides a graphical display interface for displaying various compiled score analysis of the workforce selection scores, of the individual or team, based on compability analysis or the collaboration compability analysis, for performing a specific workforce task.

According to embodiments, the displayed scores analysis can provide compatibility scores of a trait compability analysis, collaboration compatibility scores, of collaboration compability analysis, and an optimized, total fitness score for the individuals or teams, based on the compability analysis and the collaboration compability analysis, for performing a specific workforce task. The displayed compatibility scores can be presented in graphical representations of scores of individuals or candidates, for workforce selection, for performing a specific workforce task in the workforce data monitoring environment 114A, according to embodiments.

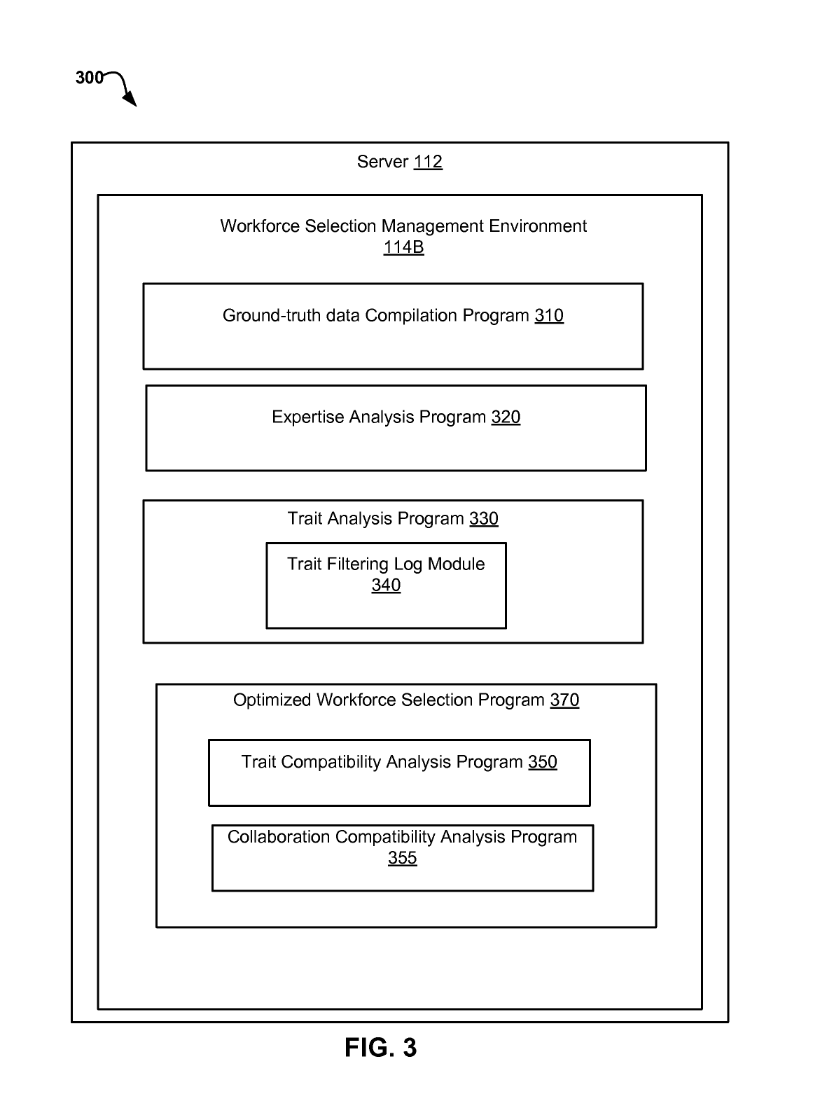

Referring now to FIG. 3, a functional block diagram 300 illustrating program components and algorithms associated with workforce selection management environment 114B, in accordance with embodiments. As previously described, the workforce selection management environment 114B performs all necessary functions to optimize information for workforce selection, based on modeling of intrinsic traits and expertise of an individual or teams, within the workforce selection system 100. For example, according to embodiments, the workforce selection management environment 114B performs optimization of information for workforce selection of a task, or project, based of intrinsic traits and expertise of a plurality of candidates, of the workforce selection, and transmits analyzed compability or collaboration data of the optimized information, of the teams or individuals, as scores, for display in an interface of the client workforce monitoring data environment 114A, according to embodiments. The workforce selection management environment 114B includes ground truth data compilation program 310, expertise analysis program 320, trait analysis program 330, and optimized workforce selection program 370.

Ground truth data compilation program 310 is a data collection program that compiles data of expertise, or traits of individual candidates, or a team of candidates, for the workforce selection, of a task, or project, based on modeling of intrinsic traits and expertise of the collected data. The collected data can be work related knowledge, or skills of the individual or teams, historical performance evaluations of the individual or teams, or success rates of previous problems or historical records of workflows performed by the individual, or teams, within an organization, or a company.

As previously described, the collected data can be ground truth data collection of information from multi-media contents, such as, pre-computed knowledge based information, or analyzed data of social media contents, including, identified tags of multi-media contents of a text-based data, a voice-based data, or a video-based data of incoming media stream pertaining to the individual or team. For example, for a given workforce selection task, of an entity, such as, an organization, or a company, the collected data of the ground truth data compilation program 310 is optimized for workforce selection, of a task, or a project, based on modeling of intrinsic traits, or expertise of individuals or teams, whom are candidates of the workforce selection. The collected data may be retrieved from an organization's one or more divisions, such as, for instance, human resource department, sales department, or finance department, of the individual or team. In one embodiment, such collected data may based on a selection of high performers of the candidates of individuals or teams.

In such case, for example, the ground-truth collected data consists of a set of individuals people who received high performance rating in the last one or more years assessment of the company or the organization, and another set of people who received lower rating in such assessments. In another embodiment, such ground-truth collected data is based on compiled data of a set of groups of teams, which are high performing groups, or teams, in an organization. The ground-truth collected data can be based on collected data of groups, or teams that are low performing groups, or teams of the organization. According to embodiments, performance of a group can be measured by average performance of its members by ground truth data compilation program 310, once the ground truth data is collected, the ground truth data is compiled, and stored in workforce data repository 120. In yet another embodiment, performance of the group can also be measured by achievement levels, of the individuals, or teams, in a previous project of the organization, or company, or based on a milestone achievement of the individual, or team of the organization, according to embodiments.

Expertise analysis program 320 computes an expertise characteristics score, or features of the individual or team, based on the ground-truth collected data of ground truth data compilation program 310, whereby expertise analysis program 320 retrieves the expertise characteristics, or features, of the individuals or teams, from workforce data repository, for computing expertise features of candidates, of the individuals, or teams, for the workforce selection, and determines expertise for the workforce selection, for performing the task, according to embodiments. The expertise of an individual such as qualification, experience, preference, or knowledge is available through pre-computed knowledge-base, text data or survey, of the ground-truth collected data, which may be stored in workforce data repository. Expertise analysis program 320 utilizes the stored ground-truth collected data, for computing expertise features of candidates, of the individuals, or teams, for the workforce selection.

Trait analysis program 330 computes a trait characteristic score, based on trait characteristics, or features of the individual or team, of the ground-truth collected data of ground truth data compilation program 310, for the workforce selection. The trait characteristics may include personality, or basic human values of the individual or team, whereby the trait characteristics are computed from textual data of the individual or team, for the workforce selection. The textual data can be based on enterprise media content such as, social media contents, including, identified tags of multi-media contents of a text-based data, a voice-based data, or a video-based data of incoming media stream pertaining to the individual or team. Examples of such textual data can be Wikis, blogs, or external social media data such as tweets, blogs.

The textual data may also be based on writing samples from various electronic or non-electronic documents of the individual, or team, such as, for instance, emails, or social media entities. The voice-based data may comprise a speech, or voice recording of the individual or team, whereby the speech, or voice recording is converted a voice-based data for analyzing personality or basic human values of the individual or team. For example, conversion of the voice-based data may be based on linguistic inquiry and word count (LIWC) analysis, by the text analysis software module of the trait analysis program that computes the degree to the candidates of individuals, or teams, for the workforce selection use different categories of words across a wide array of texts, including emails, speeches, poems, or transcribed daily speech, whereby the text analysis software module determines multiple trait dimensions, such as, of positive or negative emotions of the individual or team, word usage of the individual or team, or knowledge based criteria of the individuals, or terms, based on the textual data of the trait characteristics of the ground-truth collected data.

Trait analysis program 330 includes trait filtering log module 340. The trait filtering log module 340 filters candidates for the workforce selection based on the computed expertise of expertise analysis program 320 and computed trait characteristics of trait analysis program 330, of the individuals, or teams, for the workforce selection, according to embodiments. The desired trait characteristics may be configured in trait filtering log module 340, by a client, or systems administrator, of trait analysis program 330, for the workforce selection, of the individuals, or teams, according to embodiments. For example, it may desired that the individuals, or teams member of the workforce are not depressed, or are not extravert, or likewise, are not hedonist.

As such, based on the desired characteristics, configured by trait analysis program 330, of the individuals, or teams, for the workforce selection, individuals who score very low for desired characteristics, where high value is required are filtered out of the desired workforce team, by the trait filtering log module 340. Similarly, people who score very high for desired trait, or expertise characters, where low value is required, are also filtered out of the workforce selection by the trait filtering log module. Thereafter, the trait filtering log module 340 filters individuals, or teams of the workforce selection, who do not violate any desired trait characteristics, based on desired trait characteristics, computed by trait filtering log module, or those who score high on desired trait characteristics, according to embodiments.

Optimized workforce selection program 370 optimizes a total fitness score for individual candidates or a team of candidates for performing a specific task, based on results of the trait compability analysis and the collaboration compability analysis. The optimized workforce selection program 370 includes trait compatibility analysis program 350 and collaboration compatibility analysis program 355. The trait compatibility analysis program 350 utilizes a supervised model that determines compatibility of the potential candidates for the group, based on co-efficient of the expertise and, traits characteristics, as functions of the candidate of the individuals, or teams, for performing a specific workforce task of the workforce selection.

The trait compability analysis program 350 provides a compatibility score of potential candidates, of the plurality of candidates, for a group, the trait compability analysis utilizes a supervised model that determines compatibility of the potential candidates for the group, based on co-efficient of the expertise and traits characteristics, as functions of the potential candidates. For example, given the prior history of team's or individual's success/failure of a workforce, the trait compability analysis is utilized to train a supervised compability model which provides compatibility of a group of people in terms of trait, for performing a given task of the workforce. For example, the supervised model of the trait compability analysis can be based on the following equation:

Cp(U)=ΣₖωₖDk(pᵤ₁^{k},pᵤ₂^{k}, . . . ,pᵤₙ^{k})
where U={uᵢ, iε[1,n]} are the set of candidate users, individuals or team;
ωₖ are weighting coefficients learned through training data of the supervised model.
Dk are the group fitness measure for trait feature k, which can be defined as functions of the individuals, or users in a group on a per trait basis. For instance, for neuroticism, Dk can be a measure reflecting how small the overall value is across all users, because low neuroticism is universally desirable. In contrast, for extraversion, we may want to assign Dk as higher when the values are diverse across users, so that we obtain a mixture of introverts and extroverts. These group fitness measures (Dk) are determined based on domain expertise, or can also be established through a learning algorithm.

The trait compatibility analysis program 350 is useful for varieties of embodiment of this disclosure. For example, when forming a team, the trait compability analysis program 350 is adaptive to provide a compatibility score for a group of people who are potential members of the team. Further, for recruiting a person to a team (when multiple possible existing teams are candidate), such trait compatibility analysis can be done by adding that person to each such team. As such, trait compatibility analysis program 350 provides a compatibility score of potential candidates, of the plurality of candidates, for a group, based on the supervised model that determines compatibility of the potential candidates for the group, according to embodiments. Collaboration compability analysis program 355 computes a collaboration compatibility score of potential candidates of the plurality of candidates, for performing a task of the workforce by a pair of candidates, based on prior collaboration history and collaborative expertise and collaborative traits characteristics of the potential candidates for the workforce selection. The intuition is that collaboration compatibility is based on collaboration history of the two users as well as a factor of collaboration compatibility between their top collaborators. The collaboration compability analysis program 355 is useful when workforce selection task is either is either to form a team from a set of available candidates, or recruit an individual to a team (when multiple candidate teams are available). For example, for a given team formation task, when a set of candidate individuals are provided, the collaboration compability analysis program 355 computes collaboration compatibility score for every pair of candidates, for the workforce, according to embodiments.

For example, when selecting an individual to a team, when multiple candidate teams are given, a collaboration compatibility analysis is performed between that individual and every other team members, by the collaboration compatibility analysis program 355. For example, for a pair of individuals (u, v), a collaboration compatibility score is determined by the collaboration compatibility analysis program 355, based on their prior collaboration history of the pair of individuals, for the workforce selection. Therefore, if user u and v have collaborated in past, a graph may be created in which the edge between u and v is created and optionally the edge weight indicates how good the collaboration was between these two people. Then, between two users, the collaboration compatibility analysis program 355 computes their compatibility similarity based on the following formulas:

Cc(u,v)=w(u,v)+r*[\sum_x,yCc(x,y)/(|N(u)|*|N(v)|)] where x belongs to N(u), y belongs to N(v).
here N(u) are top t collaborators of u
   |N(u)| is size of set N(u).
w(u,v) is the edge wt between u and v in collaboration graph.

Once the trait compability score and a collaboration compability score has been computed, the optimized workforce selection program 370 applies an optimized based approach for selecting the workforce. For example, the optimized workforce selection program 370 optimizes a total fitness score for individual candidates or a team of candidates for performing a specific task, based on results of the trait compability analysis and the collaboration compability analysis, based on expertise of the workforce and the task goal of the workforce, while finding the workforce who are best compatible in terms of trait and collaboration history. This optimization approach is applicable for either team formation or selecting individual to a candidate team tasks.

For team formation, a user may want to optimize the following:

argmin_{U}*Cc(U)+Cp(U)
s.t. F(E(U), Task) is true
   size (U)=K
      Where F(E(U), Task) is the coverage constraint. It should be satisfied for the workforce selection. The coverage constraint captures the required skills from the selected workforce towards the task. Cc is the collaboration compatibility; and Cp is the compatibility of personality.

The optimization approach can also be based on a greedy based solution for optimizing selection of the workforce. The greedy based solution can be, for instance, let the task requires x skills Create x ranked lists of people (say with a size of k per skill) with decreasing order of their expertise E(U) on xth skill; Pick one user (say u) randomly from the top of one of the ranked list (or the one from the most important skill if there is a priority amongst those skills); Set U={u}; Rank all the users on their Cc+Cp score; Pick the highest ranked user (say v) from this ranked list which has the skill not in set U. If no such user exists then F constraint is established. In this case pick the top most user (say v) from this ranked list; Set U=U union v; Repeat step 4-6 until |U|=K

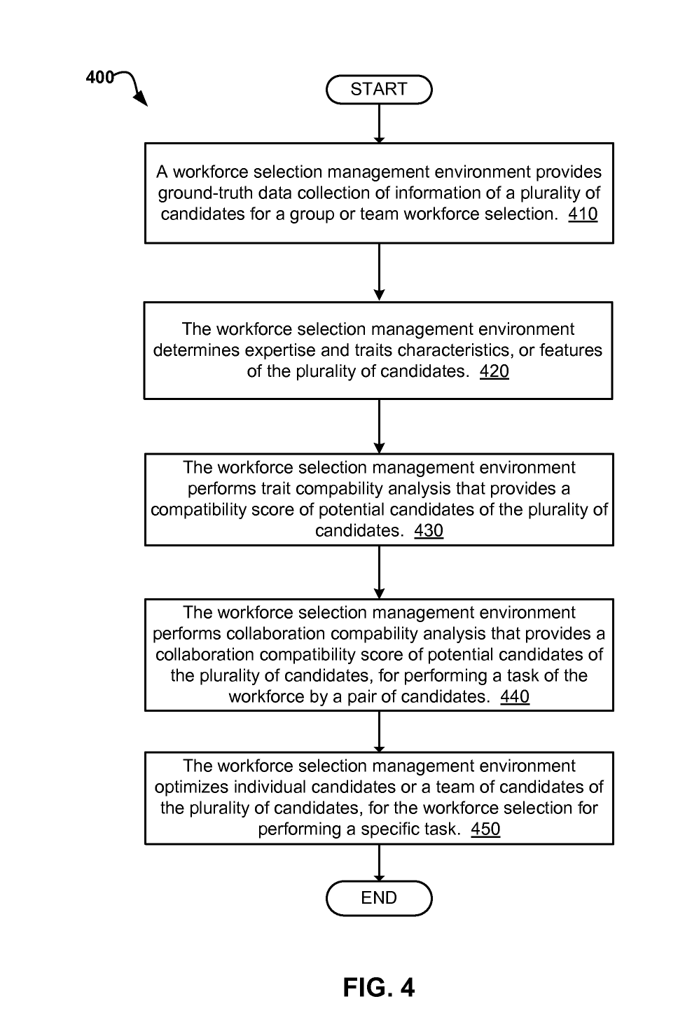

Referring now to FIG. 4, is an operational flowchart 400, illustrating steps performed by workforce selection management environment 114B, for optimizing information, for workforce selection, based on modeling of intrinsic traits and expertise of an individual or a team, according to embodiments.

At step 410, expertise analysis program provides ground truth data collection via the workforce selection management environment 114B of server 112, for workforce selection based on based on modeling of intrinsic traits and expertise of an individual or teams, within the workforce selection system 100, whereby the ground truth data collection is retrieved from workforce data repository 120, for optimizing information for workforce selection. Next, at 420, the workforce selection management environment 114B determines expertise and traits characteristics, or features of the plurality of candidates, based on the ground-truth data collection, for the group or team workforce selection, according to embodiments. For example, workforce selection management environment 114B filters the candidates for the workforce selection, based on desired trait characters, of the expertise and traits characteristics, as described above. Also, the desired trait characteristics are based on a plurality of personality dimensions of the plurality of candidates, for the workforce selection.

Next, at 430, the workforce selection management environment 114B performs trait compability analysis that provides a compatibility score of potential candidates, of individuals or teams, for the workforce selection, the trait compability analysis program 370 utilizes a supervised model that determines compatibility of the potential candidates for the group, based on co-efficient of the expertise and traits characteristics, as functions of the potential candidates. Next, at 440, the workforce selection management environment 114B performs collaboration compability analysis that provides a collaboration compatibility score of potential candidates, of individuals or teams, for the workforce selection, for performing a task of the workforce by a pair of potential candidates, for the workforce selection, based on prior collaboration history and collaborative expertise and collaborative traits characteristics of the potential candidates. Next, at 450, the workforce selection management environment 114B optimizes individual candidates or a team of candidates of the plurality of candidates, for the workforce selection for performing a specific task, based on results of the compability analysis and the collaboration compability analysis.

FIG. 5 is a block diagram 500 of internal and external components of computers depicted in FIG. 1 in accordance with an illustrative embodiment. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Client workforce data monitoring environment 114 A (FIG. 1), and workforce selection management environment 114B (FIG. 1) may include respective sets of internal components 800a, b and external components 900a, b illustrated in FIG. 5. Each of the sets of internal components 800a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and software programs 108 (FIG. 1) in computer 102 (FIG. 1) is stored on one or more of the respective computer-readable tangible storage medium 830 for execution by one or more of the respective processors 820 via one or more of the respective RAMs 822 (which typically include cache memory). In the embodiment illustrated in FIG. 5, each of the computer-readable tangible storage medium 830 is a magnetic disk storage device of an internal hard drive.

Alternatively, each of the computer-readable tangible storage medium 830 is a semiconductor storage device such as ROM 824, EPROM, flash memory or any other computer-readable tangible storage device that can store a computer program and digital information. Each set of internal components 800a, b also includes a R/W drive or interface 832 to read from and write to one or more portable computer-readable tangible storage medium 936 such as a CD-ROM, DVD, memory stick, magnetic tape, magnetic disk, optical disk or semiconductor storage device. A software program 108 (FIG. 1), such as Client Workforce Data Monitoring Environment 114 A (FIG. 1) can be stored on one or more of the respective portable computer-readable tangible storage medium 936, read via the respective R/W drive or interface 832 and loaded into the respective hard drive 830.

Each set of internal components 800a, b also includes network adapters or interfaces 836 such as a TCP/IP adapter cards, wireless Wi-Fi interface cards, or 3G or 4G wireless interface cards or other wired or wireless communication links. The software program 108 (FIG. 1) and client workforce data monitoring environment 114 A (FIG. 1) in computer 102 (FIG. 1) and workforce selection management environment 114B (FIG. 1), can be downloaded to computer 102 (FIG. 1) and server 112 (FIG. 1), respectively from an external computer via a network (for example, the Internet, a local area network or other, wide area network) and respective network adapters or interfaces 836. From the network adapters or interfaces 836, the code software programs 108 (FIG. 1) and client workforce data monitoring environment 114A (FIG. 1) in computer 102 (FIG. 1) and workforce management environment 114B in server 112 (FIG. 1) are loaded into the respective hard drive 830. The network may comprise copper wires, optical fibers, wireless transmission, routers, firewalls, switches, gateway computers and/or edge servers.

Each of the sets of external components 900a, b can include a computer display monitor 920, a keyboard 930, and a computer mouse 934. External components 900a, b can also include touch screens, virtual keyboards, touch pads, pointing devices, and other human interface devices. Each of the sets of internal components 800a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimizing information for workforce selection, based on modeling of intrinsic traits and expertise of an individual or a team, the computer-implemented method comprising:
providing a ground-truth data collection of information of a plurality of candidates for a group or a team workforce selection, the ground-truth data collection includes performance rating assessments of the candidates;
determining at least one expertise and at least one trait characteristic, or at least one feature of each of the candidates within the plurality of candidates, based on the ground-truth data collection, for the group or the team workforce selection;
performing a trait compability analysis that provides a compatibility score of potential candidates, of the plurality of candidates, for the group, the trait compability analysis utilizes a supervised model that determines compatibility of the potential candidates for the group, based on a co-efficient of the expertise and traits characteristics, as functions of the potential candidates;
performing a collaboration compability analysis that provides a collaboration compatibility score of plurality of potential candidate within the plurality of candidates, for performing a task of the workforce by a pair of candidates, based on a prior collaboration history and a collaborative expertise and a plurality of collaborative traits characteristics of the plurality of potential candidates; and
optimizing at least one individual candidate or a team of candidates within the plurality of candidates, for the workforce selection for performing a specific task, based on a result of the trait compability analysis and the collaboration compability analysis.

2. The computer-implemented method according to claim 1, further comprising: filtering the plurality of candidates for the workforce selection, based on desired trait characters of the expertise and traits characteristics of the plurality of candidates.

3. The computer-implemented method according to claim 2, wherein the desired trait characteristics are based on a plurality of personality dimensions of the plurality of candidates, for the workforce selection.

4. The computer-implemented method according to claim 1, wherein the ground-truth data collection is based on a compilation workforce data, or a survey from an organization, or a plurality of data of multi-media contents of the plurality of candidates.

5. The computer-implemented method according to claim 1, wherein the expertise characteristic comprises at least one of a plurality of qualifications, a plurality of experiences, or a plurality of knowledge of the plurality of candidates.

6. The computer-implemented method according to claim 1, wherein the trait characteristic comprises at least one of a personality or a humanistic value of the plurality of candidates.

7. The computer-implemented method according to claim 1, wherein the optimizing step further comprises: compiling a total fitness score for the at least one individual candidate or the team of candidates within the plurality of candidates, for performing a specific workforce task.

8. A computer system for optimizing information for workforce selection, based on modeling of intrinsic traits and expertise of an individual or a team, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to provide a ground-truth data collection of information of a plurality of candidates for a group or a team workforce selection, the ground-truth data collection includes performance rating assessments of the candidates;
program instructions to determine at least one expertise and at least one trait characteristic, or at least one feature of each of the candidates within the plurality of candidates, based on the ground-truth data collection, for the group or the team workforce selection;
program instructions to perform a trait compability analysis that provides a compatibility score of potential candidates, of the plurality of candidates, for the group, the trait compability analysis utilizes a supervised model that determines compatibility of the potential candidates for the group, based on a co-efficient of the expertise and traits characteristics, as functions of the potential candidates;
program instructions to perform a collaboration compability analysis that provides a collaboration compatibility score of plurality of potential candidate within the plurality of candidates, for performing a task of the workforce by a pair of candidates, based on a prior collaboration history and a collaborative expertise and a plurality of collaborative traits characteristics of the plurality of potential candidates; and
program instructions to optimize at least one individual candidate or a team of candidates within the plurality of candidates, for the workforce selection for performing a specific task, based on a result of the trait compability analysis and the collaboration compability analysis.

9. The computer system according to claim 8, further comprises: program instruction to filter the plurality of candidates for the workforce selection, based on desired trait characters of the expertise and traits characteristics of the plurality of candidates.

10. The computer system according to claim 9, wherein the desired trait characteristics are based on a plurality of personality dimensions of the plurality of candidates, for the workforce selection.

11. The computer system according to claim 8, wherein the ground-truth data collection is based on a compilation workforce data, or a survey from an organization, or a plurality of data of multi-media contents of the plurality of candidates.

12. The computer system according to claim 8, wherein the expertise characteristic comprises at least one of a plurality of qualifications, a plurality of experiences, or a plurality of knowledge of the plurality of candidates.

13. The computer system according to claim 8, wherein the trait characteristic comprises at least one of personality or humanistic values of the plurality of candidates.

14. The computer system according to claim 8, wherein the optimizing step further comprises: compiling a total fitness score for the individual candidates or the team of candidates of the plurality of candidates, for performing a specific workforce task.

15. A computer program product for optimizing information for workforce selection, based on modeling of intrinsic traits and expertise of an individual or a team, the computer program product comprises:
one or more computer-readable tangible storage devices and program instructions stored on at least one of the one or more storage devices, the program instructions comprising:
program instructions to provide a ground-truth data collection of information of a plurality of candidates for a group or a team workforce selection, the ground-truth data collection includes performance rating assessments of the candidates;
program instructions to determine at least one expertise and at least one trait characteristic, or at least one feature of each of the candidates within the plurality of candidates, based on the ground-truth data collection, for the group or the team workforce selection;
program instructions to perform a trait compability analysis that provides a compatibility score of potential candidates, of the plurality of candidates, for the group, the trait compability analysis utilizes a supervised model that determines compatibility of the potential candidates for the group, based on a co-efficient of the expertise and traits characteristics, as functions of the potential candidates;
program instructions to perform a collaboration compability analysis that provides a collaboration compatibility score of plurality of potential candidate within the plurality of candidates, for performing a task of the workforce by a pair of candidates, based on a prior collaboration history and a collaborative expertise and a plurality of collaborative traits characteristics of the plurality of potential candidates; and
program instructions to optimize at least one individual candidate or a team of candidates within the plurality of candidates, for the workforce selection for performing a specific task, based on a result of the trait compability analysis and the collaboration compability analysis.

16. The computer program product according to claim 15, further comprises: program instruction to filter the plurality of candidates for the workforce selection, based on desired trait characters of the expertise and traits characteristics of the plurality of candidates.

17. The computer program product according to claim 16, wherein the desired trait characteristics are based on a plurality of personality dimensions of the plurality of candidates, for the workforce selection.

18. The computer program product according to claim 15, wherein the ground-truth data collection is based on a compilation workforce data, or a survey from an organization, or a plurality of data of multi-media contents of the plurality of candidates

19. The computer program product according to claim 15, wherein the trait characteristic comprises at least one of personality or humanistic values of the plurality of candidates.

20. The computer program product according to claim 15, wherein the optimizing step further comprises: compiling a total fitness score for the individual candidates or the team of candidates of the plurality of candidates, for performing a specific workforce task.
